(19) United States
(12) Patent Application Publication
(10) Pub. No.: US 2018/0131401 A1
(43) Pub. Date: May 10, 2018

(54) WIRELESS SFP MODULE

(71) Applicant: Telefonaktiebolaget LM Ericsson (publ), Stockholm (SE)

(72) Inventors: Fredrik Bonde, Torslanda (SE); Magnus Rissvik, Lindome (SE)

(21) Appl. No.: 15/567,001

(22) PCT Filed: May 6, 2015
(86) PCT No.: PCT/EP2015/059953

§ 371 Date: Oct. 16, 2017

(51) Int. Cl. H04B 1/3805; H04B 1/52; H04B 1/403; H04L 12/66

(52) U.S. Cl. CPC H04B 1/3805; H04B 1/52; H04W 84/12; H04L 12/66; H04B 1/406

(57) ABSTRACT

A communication system comprising a microwave transceiver arranged to communicate with a remote microwave transceiver over a point-to-point radio link, the microwave transceiver comprising a small form-factor pluggable, SFP, transceiver slot having an SFP interface, the communication system further comprising a wireless SFP transceiver, W-SFP, occupying the SFP transceiver slot, the W-SFP comprising an antenna port, a wireless module supporting a wireless local area network, WLAN, protocol for communicating with one or more wireless devices via the antenna port, and an SFP port supporting the SFP interface, wherein the wireless module, the SFP port, and the antenna port are interconnected and arranged as an integrated unit.

### TECHNICAL FIELD

The present disclosure relates to wireless communication systems, and in particular to a small form-factor pluggable (SFP) module with integrated wireless module, and its applications in point to point microwave radio links.

### BACKGROUND

A microwave radio link or radio link system is a communication system that transmits data between two fixed locations over a point-to-point link. A microwave radio link transmitter and receiver are often incorporated into one unit, herein denoted as microwave transceiver.

Wireless local area networks (WLAN) are networks that can be used to provide access for one or more wireless devices to a wide area network (WAN). One solution for providing such access in a remote area is by a combination of microwave radio link and WLAN access point. Such a combination is shown in FIG. 6a.

A drawback with the type of outdoor installation shown in FIG. 6a is the need for weather protection of outdoor units, which adds to the total cost of an installation.

Power supply in communication system deployments contribute significantly to total cost of ownership (TCO). It is not only the operating expenditures (OPEX) for electrical energy which are contributing, but also capital expenditures (CAPEX) related to cables, power modules, cooling, and connectors, which all add to the total cost of an installation. There is therefore a need to minimize the number of components having individual power supplies in a communication system.

### SUMMARY

An object of the present disclosure is to provide a communication system, an SFP module, and methods which seek to mitigate, alleviate, or eliminate one or more of the above-identified deficiencies in the art and disadvantages singly or in any combination.

This object is obtained by a communication system comprising a microwave transceiver arranged to communicate with a remote microwave transceiver over a point-to-point radio link. The microwave transceiver comprises a small form-factor pluggable (SFP) transceiver slot having an SFP interface. The communication system further comprises a wireless SFP transceiver (W-SFP) occupying the SFP transceiver slot. The W-SFP comprises an antenna port, a wireless module supporting a wireless local area network (WLAN) protocol for communicating with one or more wireless devices via the antenna port, and an SFP port supporting the SFP interface. The wireless module, the SFP port, and the antenna port are interconnected and arranged as an integrated unit.

Hereby, installation and deployment of the communication system is simplified.

Also, a measure of theft protection is obtained in that the wireless module is harder to steal due to being arranged in an integrated unit directly connected to the microwave transceiver.

Furthermore, the wireless module is not in need of, or in reduced need of, weather protection, since it benefits from an existing weather protection of the microwave transceiver.

According to aspects, the wireless module comprises a wireless access point, W-AP, configured as WLAN access point for the one or more wireless devices.

According to aspects, the wireless module comprises a wireless client, W-C, configured as a WLAN client connectable to a WLAN access point, or as WLAN station arranged in peer-to-peer mode.

Thus, aspects of the communication system provide both WLAN access point and WLAN client functionality.

According to aspects, the SFP interface is arranged to pass a communications signal between the wireless module and the microwave transceiver, and the SFP interface comprises power supply. The power supply is connected to the wireless module and arranged to power the wireless module.

Hereby, there is no need for extra power supply to power the wireless module. A single power supply powers both microwave transceiver and the wireless module.

There is also disclosed herein a relay node comprising a first and a second communication system according aspects of the present disclosure. A W-SFP of the first communication system and a W-SFP of the second communication system are configured to relay a communications signal between the microwave transceivers of the first and second communication systems.

There is further disclosed herein a microwave radio link arrangement configured in protection mode, comprising a main and an auxiliary communication system according aspects of the present disclosure. A W-SFP of the main communication system and a W-SFP of the auxiliary communication system are configured to relay a communications signal between the microwave transceiver of the auxiliary communication system and the microwave transceiver of the main communication system via respective antenna ports. The main microwave transceiver further comprises a processing device comprising a protection switch. The protection switch is configured to select an active communication signal from the communications signal of the main microwave transceiver and the communications signal of the auxiliary microwave transceiver.

There is additionally disclosed herein a microwave radio link arrangement configured in bonding mode, comprising a main and an auxiliary communication system according aspects of the present disclosure. A W-SFP of the main communication system and a W-SFP of the auxiliary communication system are configured to relay a communications signal between the microwave transceiver of the auxiliary communication system and the microwave transceiver of the main communication system via respective antenna ports. The main microwave transceiver further comprises a processing device comprising a bonding module. The bonding module is configured to bond the communication signals of the main and auxiliary communication systems and to output a bonded communication signal.

The above-mentioned object is also obtained by a wireless small form-factor pluggable, SFP, transceiver (W-SFP) comprising an antenna port, a wireless module supporting a wireless local area network (WLAN) protocol for communicating with one or more wireless devices via the antenna port, and an SFP port supporting an SFP interface. The wireless module, the SFP port, and the antenna port are interconnected and arranged as an integrated unit.

In addition, there is presented a method of communication in a communication system. The method comprises occupying a small form-factor pluggable (SFP) transceiver slot of a microwave transceiver by a wireless SFP transceiver, (W-SFP), and communicating, by the microwave transceiver, over a point-to-point radio link, with a remote microwave transceiver, as well as communicating with one or more wireless devices by a wireless module integrated in the W-SFP and supporting a wireless local area network, WLAN, protocol.

Apart from the above method, there is also provided herein computer programs comprising computer program code which, when executed in a communication system causes the communication system to execute methods according to the present teaching.

The W-SFP, radio link configurations, computer programs, and the methods all display advantages corresponding to the advantages already described in relation to the communication system.

### BRIEF DESCRIPTION OF THE DRAWINGS

Further objects, features, and advantages of the present disclosure will appear from the following detailed description, wherein some aspects of the disclosure will be described in more detail with reference to the accompanying drawings, in which:

FIG. 1 is a block diagram illustrating a communication system according to aspects of the disclosure.

FIG. 2 is a block diagram illustrating a wireless small form-factor pluggable (W-SFP) device according to aspects of the disclosure.

FIGS. 3-5 are block diagrams illustrating communication systems according to aspects of the disclosure.

FIG. 6a is a block diagram illustrating a communication system according to prior art.

FIG. 6b is a block diagram illustrating a communication system according to aspects of the disclosure.

FIG. 7 is a flowchart illustrating methods according to aspects of the disclosure.

FIG. 8 is a block diagram illustrating a wireless small form-factor pluggable (W-SFP) device according to aspects of the disclosure.

### DETAILED DESCRIPTION

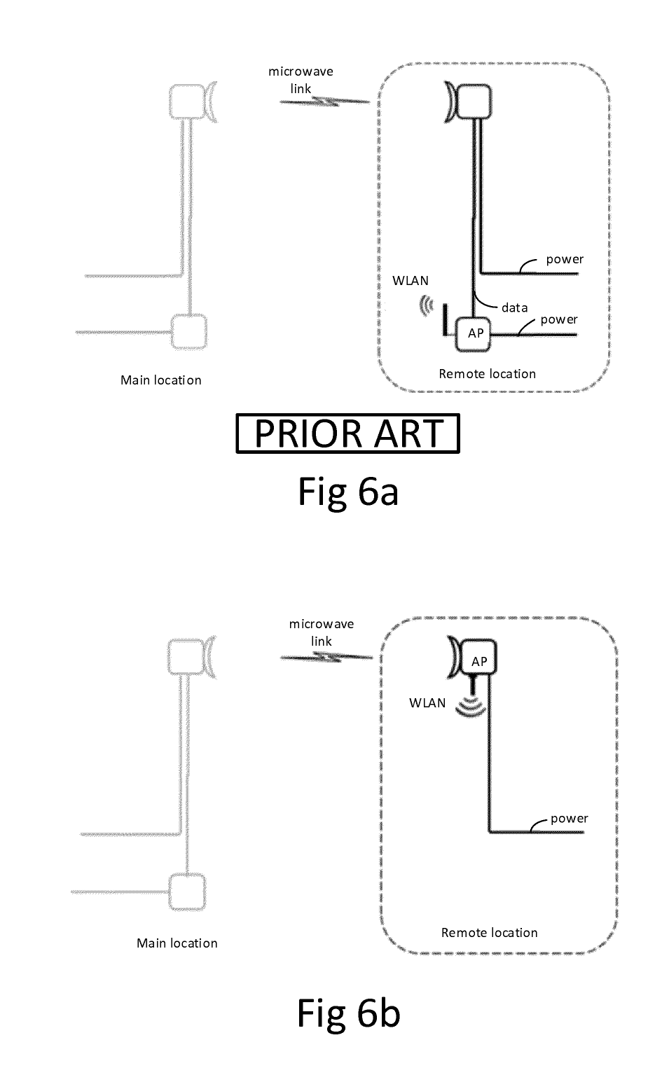

FIG. 6a is a block diagram illustrating a communication system according to prior art. A remote location is connected to an outside network, such as a wide area network (WAN) via microwave link to a main location. There is a need to provide wireless local area network (WLAN) access in the remote location, and therefore a WLAN access point (AP) is deployed at the remote location. The WLAN AP needs a power supply and a data connection to the microwave transceiver maintaining the microwave link.

Thus, typically, one needs a two box solution, including a WLAN access point complete with antenna, power supply unit, and power cabling. The WLAN access point often needs to be of weatherproof design. Furthermore, the WLAN access point is normally built in to a separate box with switch and router capabilities. As already mentioned above, cabling and weather shielding adds to total cost of ownership (TCO).

FIG. 6b is a block diagram illustrating a communication system according to aspects of the disclosure. It is appreciated that FIG. 6b is not part of the prior art. Instead, problems related to the solution shown in FIG. 6a are here solved by a new device; a wireless small form-factor pluggable (SFP) transceiver (W-SFP), which, according to some aspects, is inserted directly into a standard SFP cage or slot on the microwave transceiver.

The W-SFP holds the WLAN wireless module electronics with antenna connector. Power, access point configuration facilities and communication signal interface, e.g., data interface, is supplied through the normal SFP connector to the radio link equipment. Hence, there is no need for external power or control channel connections, which is an advantage.

Weather protection for the W-SFP is achieved by the normal outdoor connector solution of the radio link equipment.

It is appreciated that the W-SFP device discussed herein is different from a base station, such as a pico RBS serving wireless devices via long-term evolution (LTE) radio interfaces or similar. Thus, the WLAN access point discussed herein is not a cellular access point.

The WLAN networks and protocols discussed herein naturally comprise the well-known 802.11 family of protocols, and the WLAN protocols known as Wi-Fi protocols. However, according to different aspects, WLAN protocol discussed herein comprises Wi-Fi protocols as defined or approved by Wi-Fi alliance, ZigBee protocols as defined or approved by ZigBee alliance, or members of the IEEE 802.11 family of wireless access protocols, or WirelessHART protocols, or ISA100.11a protocols.

Aspects of the present disclosure will now be described more fully with reference to the accompanying drawings. The apparatus, computer program and methods disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the invention. As used herein, the singular forms “a”, “an” and “the” are intended to include the plural forms as well, unless the context clearly indicates otherwise.

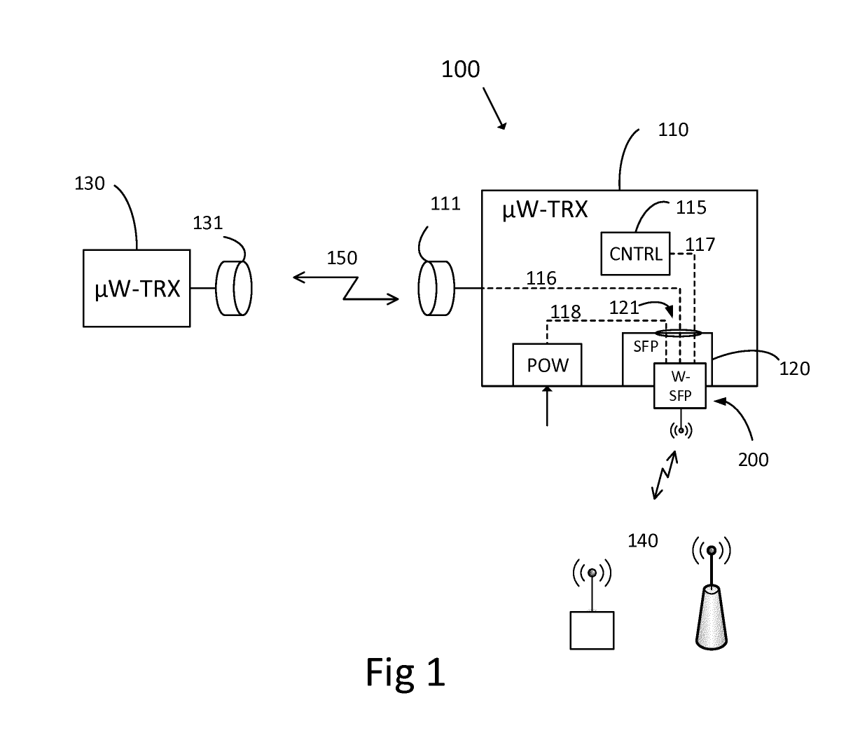

Turning now to the block diagram shown in FIG. 1, where a communication system 100 communicating with a remote microwave transceiver 130 is shown. The communication is taking place via antennas 111, 131, which according to some aspects are highly directive antennas providing long range communication.

The communication system 100 comprises a microwave transceiver 110 arranged to communicate with the remote microwave transceiver 130 over a point-to-point radio link 150. The microwave transceiver 110 comprises a small form-factor pluggable (SFP) transceiver slot having an SFP interface.

Aspects of this disclosure include use of standard SFP interfaces as well as modified SFP interfaces including a novel WLAN control signal. The SFP interface will be discussed in more detail below.

The communication system 100 further comprises a wireless SFP transceiver (W-SFP) 200 occupying the SFP transceiver slot 120. The W-SFP 200 comprises an antenna port 230, a wireless module 220 supporting a wireless local area network (WLAN) protocol for communicating with one or more wireless devices 140 via the antenna port 230, and an SFP port 210 supporting the SFP interface. The wireless module 220, the SFP port 210, and the antenna port 230 are interconnected and arranged as an integrated unit 250.

It is appreciated that the wireless module 220, in order to support said WLAN protocol for communicating with one or more wireless devices, comprises the necessary signal processing hardware and software in order to enable the communicating over the air interface of the WLAN protocol. Thus, herein, ‘supporting a WLAN protocol’ is to be interpreted broadly to comprise supporting, e.g., a given air interface, a given modulation format, a given medium access control scheme, etc.

Thus, a microwave transceiver comprising an SFP slot, or cage, is easily equipped with a WLAN module, simply by connecting the W-SFP module to the SFP interface of the SFP slot, whereby installation and deployment of the communication system is simplified.

Also, a measure of theft protection is obtained in that the wireless module is harder to steal due to being arranged in an integrated unit. For instance, the microwave transceiver is often physically located high up in a mast or on a roof of a building, making access to the W-SFP difficult.

Furthermore, the W-SFP, and the wireless module in particular, is not in need of weather protection, since it uses an existing weather protection of the microwave transceiver.

The wireless devices 140 can be any WLAN capable device, including other W-SFP 200.

WLAN communication systems in general often comprise WLAN access points to which WLAN clients can connect. However, a WLAN system without access points can also be configured; in this case WLAN clients or stations connect directly to each other using peer-to-peer communication. One example of such a peer-to-peer WLAN system is Wi-Fi Direct, defined by Wi-Fi Alliance. The Wi-Fi Direct protocol acts as a ‘soft’ AP and includes security features. Such peer-to-peer WLAN configurations are herein referred to as WLAN stations arranged in peer-to-peer mode.

The wireless module described herein can be used as either of, or any combination of, access point, WLAN client and WLAN station configured in peer-to-peer mode, such as a Wi-Fi direct terminal, providing for flexibility. Towards this end, according to some aspects, the wireless module 220 comprises a wireless access point (W-AP) configured as WLAN access point for the one or more wireless devices. According to other aspects, the wireless module 220 comprises a wireless client (W-C) configured as a WLAN client connectable to a WLAN access point, or as WLAN station arranged in peer-to-peer mode.

The SFP interface is used for both communication of data and power supply. Consequently, the SFP interface 121 is arranged to pass a communications signal 116 between the wireless module 220 and the microwave transceiver 110, and the SFP interface 121 also comprises power supply 118. The power supply is connected to the wireless module 220 and arranged to power the wireless module.

Most wireless modules are in need of configuration before they can be used. For instance, configuration may be needed in order to set up the wireless module as an access point or as a WLAN client, or a combination of access point and client. Configuration may also be necessary in order to configure a service set identifier (SSID), one or more accounts and passwords, a frequency band channel plan, or one or more security parameters of the WLAN.

The W-SFP disclosed herein can be configured in-band using the communications signal 116 or by WLAN air interface via the antenna port 230, or out-of-band using a separate WLAN control signal 117. Thus, according to some aspects, the wireless module 220 is pre-configured with initial parameters of the WLAN protocol, and/or arranged to receive parameters of the WLAN protocol via a communications signal 116.

For example, the W-SFP may be pre-configured in order to offer access to a web-server via any of its interfaces, e.g., via the SFP interface 121 and/or over WLAN air interface via the antenna port 230. This web server can then be accessed using the communications signal in order to further configure the W-SFP and/or wireless module with additional parameters of the WLAN.

In order to provide out-of-band configuration possibilities, the SFP interface 121 is, according to some aspects, arranged to pass a WLAN control signal 117, separate from the communications signal 116 of the SFP interface 121, for configuring the wireless module 220 with parameters of the WLAN protocol.

Said configuration may be executed by the microwave transceiver, or from another remote location. In order to allow configuration by the microwave transceiver, the microwave transceiver according to some aspects comprises a control module 115 arranged to configure the wireless module 220 by sending said parameters of the WLAN protocol over the SFP interface 121 to the wireless module 220. As discussed above, the parameters can according to different aspects be sent either via the communications signal 116 or via the WLAN control signal 117, or via a combination of the communications signal 116 and the WLAN control signal 117.

The SFP interface itself, not considering the WLAN communications signal, is known. However, there is no specific name for this interface, but different names are used. Hence, according to aspects, the SFP interface comprises one out of an SFP module to Host board interface, an SFP Host Board Connector, and an SFP Host interface.

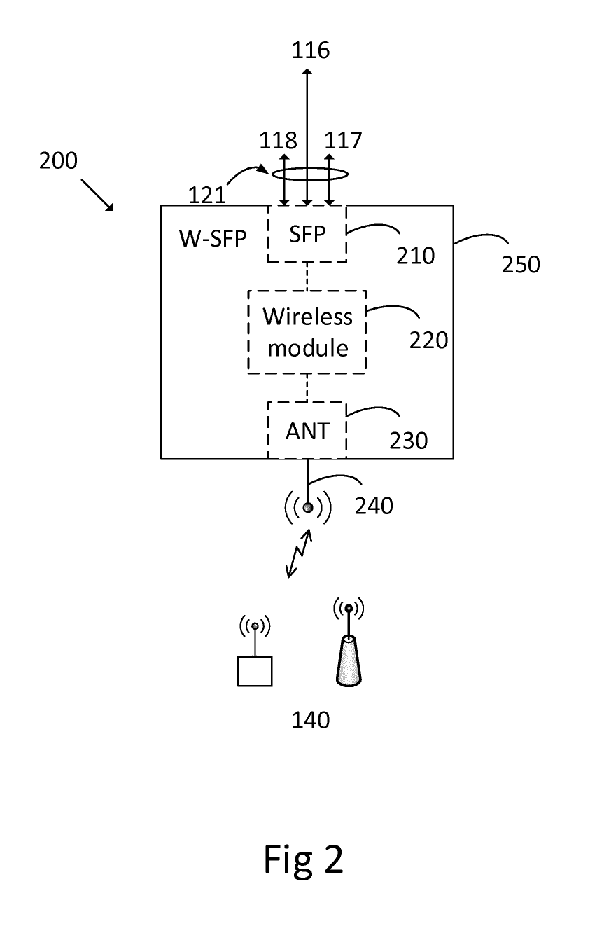

FIG. 2 is a block diagram illustrating the W-SFP 200 shown, e.g., in FIG. 1, in more detail.

The W-SFP 200 comprises an antenna port 230, a wireless module 220 supporting a WLAN protocol for communicating with one or more wireless devices via the antenna port 230, and an SFP port 210 supporting an SFP interface 121. The wireless module 220, the SFP port 210, and the antenna port 230 are interconnected and arranged as an integrated unit 250.

It is appreciated that an antenna 240 is shown in FIG. 2, but this antenna is not necessarily part of the W-SFP, which, according to some aspects, only comprises the antenna port 230. The antenna port 230 is connected to the wireless module 220, which wireless module is connected to the SFP port 210.

According to some aspects, the W-SFP further comprises an integrated antenna. This integrated antenna is then connected to the antenna port 230, and arranged together with the wireless module 220, the SFP port 210, and the antenna port 230 as an integrated unit.

The W-SFP 200 shown in FIG. 2 is associated with the same advantages and features as the W-SFP shown in FIG. 1 and discussed above. These features will therefore only be repeated here, and not discussed again.

Thus, according to aspects, the wireless module 220 comprises a wireless access point (W-AP) configured as WLAN access point for the one or more wireless devices 140, and, according to some aspects, the wireless module 220 comprises a wireless client (W-C) configured as a WLAN client connectable to a WLAN access point, or as WLAN station arranged in peer-to-peer mode.

According to aspects, the SFP interface 121 is arranged to pass a communications signal 116 between the wireless module 220 and a host device connectable to the SFP port 210, and the SFP interface 121 comprises power supply 118. The power supply is connected to the wireless module 220 and arranged to power the wireless module.

The host device can be the microwave transceiver 110 of FIG. 1, but can also be any device having one or more SFP slots or cages.

According to aspects, the wireless module 220 is pre-configured with initial parameters of the WLAN protocol, and/or arranged to receive parameters of the WLAN protocol via a communications signal 116 from a host device connectable to the SFP port 210.

According to aspects, the SFP interface 121 is arranged to pass a WLAN control signal 117, separate from the communications signal 116 of the SFP interface 121, for configuring the wireless module 220 with parameters of the WLAN protocol.

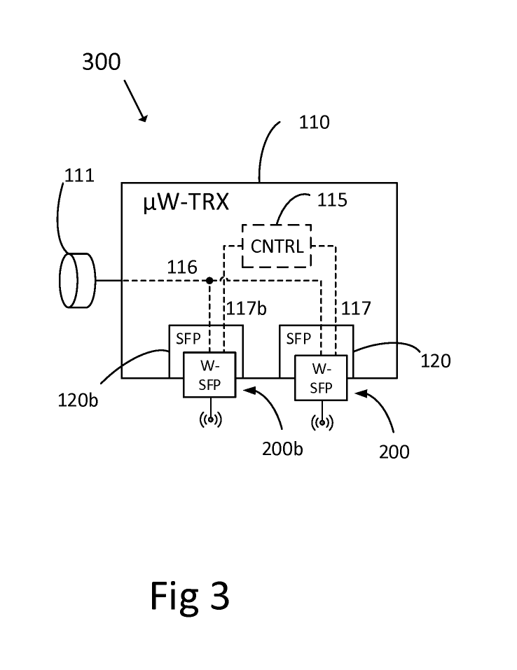

FIG. 3 is a block diagram illustrating aspects of communication systems, and in particular a microwave transceiver 110 such as the one discussed in connection to FIG. 1, but further comprising a second SFP transceiver slot 120b supporting the SFP interface, and a second W-SFP 200b configured as WLAN access point for one or more other wireless devices and occupying the second SFP transceiver slot 120b. The second W-SFP 200b comprises an antenna port 230, a wireless module 220 supporting a WLAN protocol for communicating with the one or more other wireless devices via the antenna port 230, and an SFP port 210 supporting the SFP interface. The wireless module 220, the SFP port 210, and the antenna port 230 are interconnected and arranged as an integrated unit 250.

There are many scenarios in which two or more W-SFPs can be advantageously used in parallel. For instance, according to aspects, one of the W-SFPs can be used with one WLAN protocol and the other W-SFP can be used with another WLAN protocol. Other examples include having two or more access points, with a sub-set of access points offering encrypted connections, or high-speed premium connections, or free connections. There are also configuration examples which include the use of one client and one access point running in parallel.

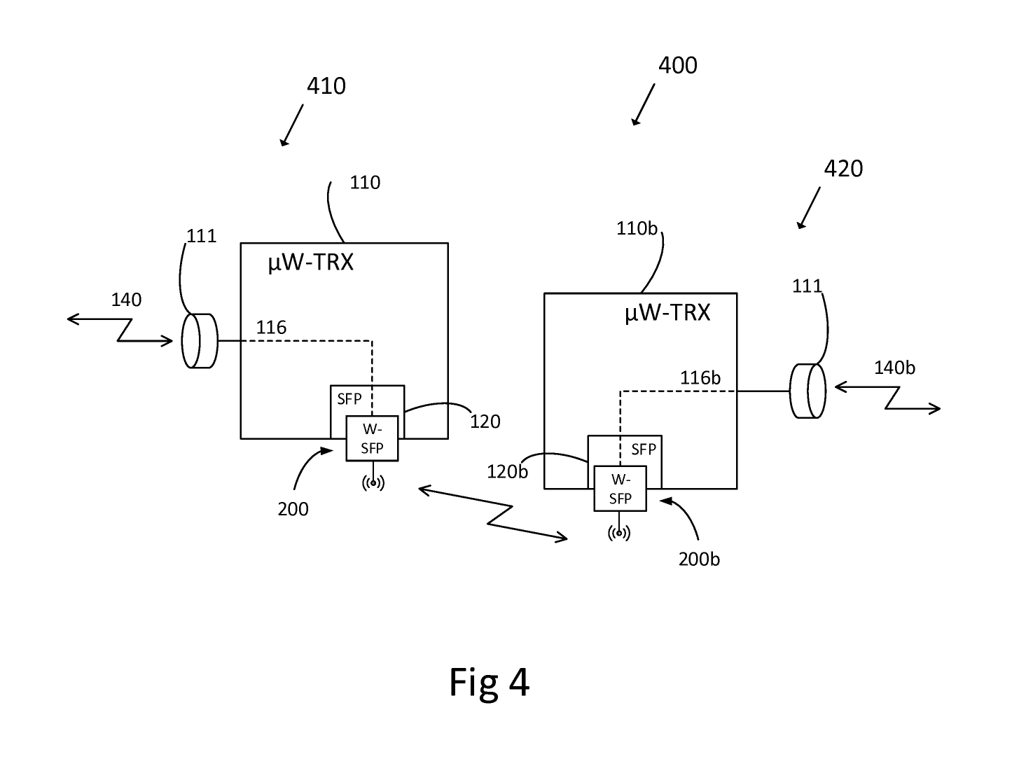

FIG. 4 is a block diagram illustrating a communication system according to aspects of the disclosure. In particular, there is shown a relay node 400 comprising a first 410 and a second 420 communication system according to the discussion above. A W-SFP 200 of the first communication system 410 and a W-SFP 200b of the second communication system 420 are configured to relay a communications signal 116, 116b between the microwave transceivers 110, 110b of the first 410 and second 420 communication systems.

Relay nodes are used, e.g., to extend the range of microwave communication to distances not coverable by a single hop. A cable usually connects the two microwave transceivers of a relay node. However, since the two microwave transceivers of the relay node are often located close together, the interconnect between them can also be via WLAN, as shown in FIG. 4. Thus, one W-SFP 200 of the first communication system 410 can be configured as access point, and the other W-SFP 200b of the second communication system 420 can be configured as client. Alternatively, the two W-SFPs can be configured as ad-hoc terminals connecting directly to each other using the type of peer-to-peer configuration discussed above, e.g., the Wi-Fi Alliance Wi-Fi Direct protocol.

Advantageously, this allows for relay nodes to be deployed without a cable interconnecting the two communication systems 410, 420, which simplifies installation.

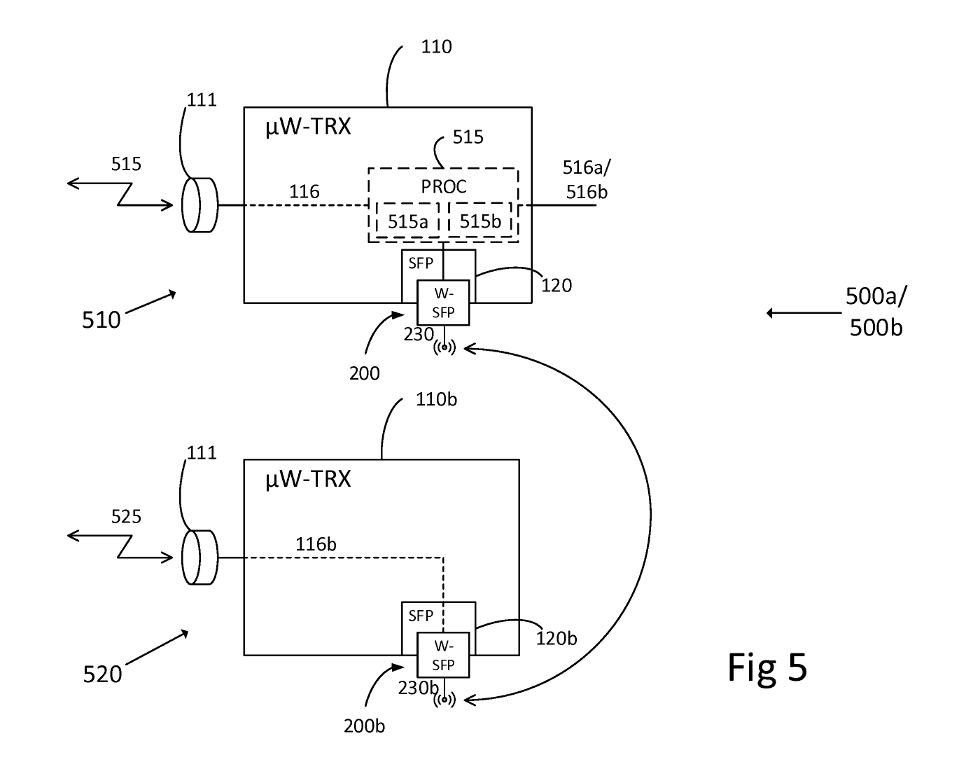

FIG. 5 is a block diagram illustrating a communication system according to aspects of the disclosure. In particular, there is shown a microwave radio link arrangement 500a configured in protection mode, comprising a main 510 and an auxiliary 520 communication system according to the discussion above. A W-SFP 200 of the main communication system 510 and a W-SFP 200b of the auxiliary communication system 510 are configured to relay a communications signal 116b between the microwave transceiver 110b of the auxiliary communication system 520 and the microwave transceiver 110 of the main communication system 510 via respective antenna ports 230, 230b. . The main microwave transceiver 110 further comprises a processing device 515 comprising a protection switch 515a. The protection switch 515a is configured to select an active communication signal 516a from the communications signal 116 of the main microwave transceiver 110 and the communications signal 116b of the auxiliary microwave transceiver 110b.

Protection systems make use of the different fading effects that can be seen at transceivers which are spaced some distance apart. Thus, if a received signal 515 at the main communication system 510 fades out, making detection difficult, there is a chance that another received signal 525 of the auxiliary communication system 520 is better. In this case the protection switch can switch in the better of the two signals, thus maintaining radio communication despite severe fading conditions.

FIG. 5 also shows a microwave radio link arrangement 500b configured in bonding mode, comprising a main 510 and an auxiliary 520 communication system according to the discussion above. A W-SFP 200 of the main communication system 510 and a W-SFP 200b of the auxiliary communication system 510 are configured to relay a communications signal 116b between the microwave transceiver 110b of the auxiliary communication system 520 and the microwave transceiver 110 of the main communication system 510 via respective antenna ports 230, 230b. The main microwave transceiver 110 further comprises a processing device 515 comprising a bonding module 515b. The bonding module 515b is configured to bond the communication signals of the main 116 and auxiliary 116b communication systems and to output a bonded communication signal 516b.

Bonding systems combine two different communication signals into one bonded communication signal 516b having higher capacity in terms of throughput than any of the constituent communication signals. Thus, for example, the main communication system 510 can be configured to communicate over a microwave radio link 515 at one frequency channel, while the auxiliary communication system 520 can be configured to communicate over a microwave radio link 525 at another frequency channel. The bonded communication signal 515b then has a total capacity corresponding to a system using both frequency channels.

Similarly to the set-up discussed in connection to FIG. 4, a cable usually connects the two microwave transceivers configured in protection or bonding mode. However, since the two microwave transceivers are often located close together, the interconnect between them can also be via WLAN, as shown in FIG. 5. Thus, one W-SFP 200 of the first communication system 410 can be configured as access point, and the other W-SFP 200b of the second communication system 420 can be configured as client. Alternatively, the two W-SFPs can be configured as ad-hoc terminals connecting directly to each other in the type of peer-to-peer configuration discussed above.

Advantageously, this allows for radio links in protection or bonding mode to be deployed without a cable interconnecting the two communication systems 510, 520, which simplifies installation.

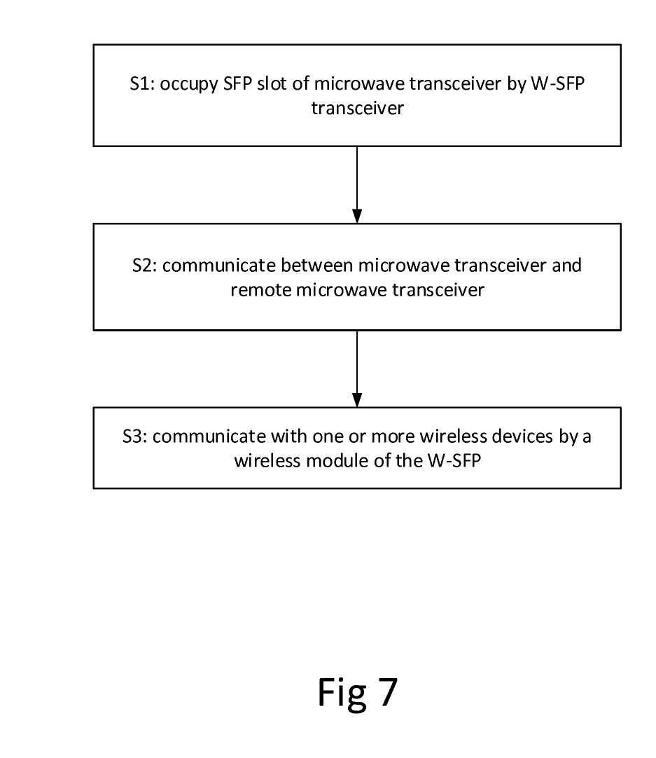

FIG. 7 is a flowchart illustrating methods according to aspects of the disclosure. There is illustrated a method of communication in a communication system. The method comprises occupying S1 an SFP transceiver slot 120 of a microwave transceiver 110 by a W-SFP 200, and communicating S2, by the microwave transceiver 110, over a point-to-point radio link, with a remote microwave transceiver 130, as well as communicating S3 with one or more wireless devices 140 by a wireless module 220 integrated in the W-SFP and supporting a wireless local area network, WLAN, protocol.

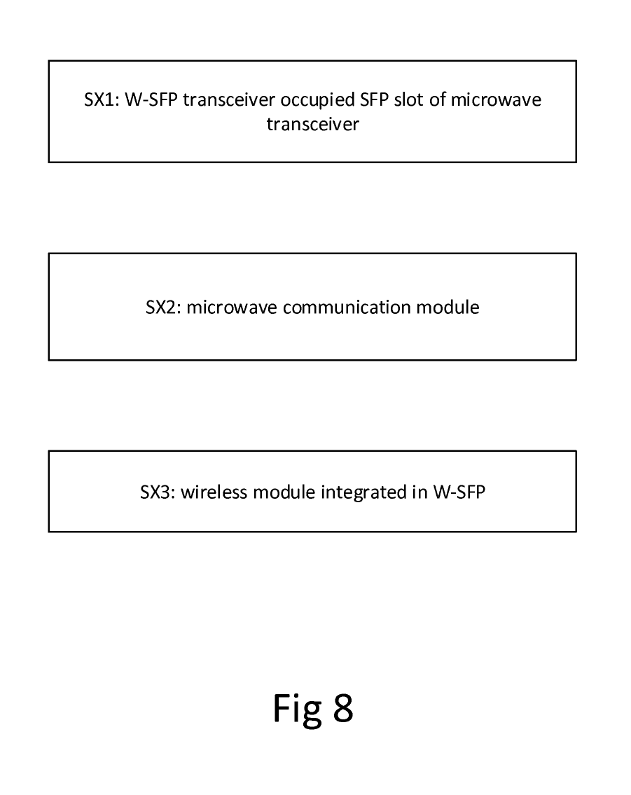

FIG. 8 is a block diagram illustrating a communication system according to aspects of the disclosure. The communication system comprises a W-SFP transceiver occupied SFP slot, a microwave communication module configured to communicate over a point-to-point radio link with a remote microwave transceiver, and a wireless module integrated in a W-SFP supporting a WLAN protocol and configured to communicate with one or more wireless devices using the WLAN protocol.

The various aspects of the methods described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc., that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

1. A communication system comprising a microwave transceiver arranged to communicate with a remote microwave transceiver over a point-to-point radio link, the microwave transceiver comprising a small form-factor pluggable, SFP, transceiver slot having an SFP interface, the communication system further comprising a wireless SFP transceiver, W-SFP, occupying the SFP transceiver slot, the W-SFP comprising an antenna port, a wireless module supporting a wireless local area network, WLAN, protocol for communicating with one or more wireless devices via the antenna port, and an SFP port supporting the SFP interface, wherein the wireless module, the SFP port, and the antenna port are interconnected and arranged as an integrated unit.

2. The communication system according to claim 1, wherein the wireless module comprises a wireless access point, W-AP, configured as WLAN access point for the one or more wireless devices.

3. The communication system according to claim 1, wherein the wireless module comprises a wireless client, W-C, configured as a WLAN client connectable to a WLAN access point, or as WLAN station arranged in peer-to-peer mode.

4. The communication system according to claim 1, wherein the SFP interface is arranged to pass a communications signal between the wireless module and the microwave transceiver, and wherein the SFP interface comprises power supply, the power supply being connected to the wireless module and arranged to power the wireless module.

5. The communication system according to claim 1, wherein the wireless module is pre-configured with initial parameters of the WLAN protocol, and/or arranged to receive parameters of the WLAN protocol via a communications signal.

6. The communication system according to claim 1, wherein the SFP interface is arranged to pass a WLAN control signal, separate from a communications signal of the SFP interface, for configuring the wireless module with parameters of the WLAN protocol.

7. The communication system according to claim 5, the microwave transceiver further comprising a control module arranged to configure the wireless module by sending said parameters of the WLAN protocol over the SFP interface to the wireless module.

8. The communication system according to claim 1, wherein the SFP interface comprises one out of an SFP module to Host board interface, an SFP Host Board Connector, and an SFP Host interface.

9. The communication system according to claim 1, the microwave transceiver further comprising a second SFP transceiver slot supporting the SFP interface, and a second W-SFP configured as WLAN access point for one or more other wireless devices and occupying the second SFP transceiver slot, the second W SFP comprising an antenna port, a wireless module supporting a WLAN protocol for communicating with the one or more other wireless devices via the antenna port, and an SFP port supporting the SFP interface, wherein the wireless module, the SFP port, and the antenna port are interconnected and arranged as an integrated unit.

10-12. (canceled)

13. A wireless small form-factor pluggable, SFP, transceiver, W-SFP, comprising an antenna port, a wireless module supporting a wireless local area network, WLAN, protocol for communicating with one or more wireless devices via the antenna port, and an SFP port supporting an SFP interface, wherein the wireless module, the SFP port, and the antenna port are interconnected and arranged as an integrated unit.

14. The W-SFP according to claim 13, wherein the wireless module comprises a wireless access point, W-AP, configured as WLAN access point for the one or more wireless devices.

15. The W-SFP according to claim 13, wherein the wireless module comprises a wireless client, W-C, configured as a WLAN client connectable to a WLAN access point, or as WLAN station arranged in peer-to-peer mode.

16. The W-SFP according to claim 13, wherein the SFP interface is arranged to pass a communications signal between the wireless module and a host device connectable to the SFP port, and wherein the SFP interface comprises power supply, the power supply being connected to the wireless module and arranged to power the wireless module.

17. The W-SFP according to claim 13, wherein the wireless module is pre-configured with initial parameters of the WLAN protocol, and/or arranged to receive parameters of the WLAN protocol via a communications signal from a host device connectable to the SFP port.

18. The W-SFP according to claim 13, wherein the SFP interface is arranged to pass a WLAN control signal, separate from a communications signal of the SFP interface, for configuring the wireless module with parameters of the WLAN protocol.

19. The W-SFP according to claim 13, wherein the SFP interface comprises one out of an SFP module to Host board interface, an SFP Host Board Connector, and an SFP Host interface.

20. The W-SFP according to claim 13, wherein the WLAN protocol is a Wi-Fi protocol as defined or approved by Wi-Fi alliance, or a ZigBee protocol as defined or approved by ZigBee alliance, or a member of the IEEE 802.11 family of wireless access protocols, or a WirelessHART protocol, or an ISA100.11a protocol.

21. The W-SFP according to claim 13, further comprising an integrated antenna connected to the antenna port, and arranged together with the wireless module, the SFP port, and the antenna port as an integrated unit.

22. A method of communication in a communication system, the method comprising;
occupying a small form-factor pluggable, SFP, transceiver slot of a microwave transceiver by a wireless SFP transceiver, W-SFP;
communicating, by the microwave transceiver, over a point-to-point radio link, with a remote microwave transceiver; and
communicating with one or more wireless devices by a wireless module integrated in the W-SFP and supporting a wireless local area network, WLAN, protocol.

23. (canceled)

24. A non-transitory computer readable medium comprising instructions executable by at least one processor of a node whereby the node is operable to:
occupy a small form-factor pluggable, SFP, transceiver slot of a microwave transceiver by a wireless SFP transceiver, W-SFP;
communicate, by the microwave transceiver, over a point-to-point radio link, with a remote microwave transceiver; and
communicate with one or more wireless devices by a wireless module integrated in the W-SFP and supporting a wireless local area network, WLAN, protocol.
